(19) United States
(12) Patent Application Publication
(10) Pub. No.: US 2026/0321533 A1
(43) Pub. Date: Oct. 15, 2026

(54) KEYBOARD DEVICE AND PROXIMITY SENSING METHOD

(71) Applicant: Chicony Electronics Co., Ltd., New Taipei City (TW)

(72) Inventors: Chih-Hung Lin, New Taipei City (TW); Chih-Yi Lu, New Taipei City (TW)

(73) Assignee: Chicony Electronics Co., Ltd., New Taipei City (TW)

(21) Appl. No.: 19/189,276

(22) Filed: Apr. 25, 2025

(30) Foreign Application Priority Data
Apr. 14, 2025 (TW) 114113972

(51) Int. Cl. H01H 13/81; G06F 3/041; G06F 3/044; H01H 13/02

(52) U.S. Cl. CPC H01H 13/81; G06F 3/04164; G06F 3/044; H01H 13/023; G06F 2203/04108

(57) ABSTRACT

Provided are a keyboard device and a proximity sensing method. The keyboard device includes multiple keyboard input lines, multiple keyboard output lines, a processing module, and a proximity sensing module. The processing module is coupled to the multiple keyboard input lines and the multiple keyboard output lines. The proximity sensing module is coupled to at least one of the multiple keyboard input lines and the multiple keyboard output lines. During multiple first sub-periods of a scan period, the processing module disables the proximity sensing module, and executes key sensing. During a second sub-period of the scan period, the processing module enables the proximity sensing module. The proximity sensing module executes proximity sensing.

### CROSS-REFERENCE TO RELATED APPLICATION

This application claims the priority benefit of Taiwan application serial no. 114113972, filed on Apr. 14, 2025. The entirety of the above-mentioned patent application is hereby incorporated by reference herein and made a part of this specification.

### BACKGROUND

### Technical Field

The disclosure relates to a device, and in particular relates to a keyboard device and a proximity sensing method.

### Related Art

Traditional keyboard devices equipped with proximity sensing modules need additional wires configured independently of the key circuits to serve as sensing antennas. In this regard, traditional keyboard devices equipped with proximity sensing modules have problems of larger device volume and higher device cost.

### SUMMARY

The disclosure provides a keyboard device and a proximity sensing method, which can implement a good proximity sensing function.

The keyboard device of the disclosure includes multiple keyboard input lines, multiple keyboard output lines, a processing module and a proximity sensing module. The processing module is coupled to the keyboard input lines and the keyboard output lines. The proximity sensing module is coupled to at least one of the keyboard input lines and the keyboard output lines. During multiple first sub-periods in a scan period, the processing module disables the proximity sensing module, and executes key sensing. During a second sub-period in the scan period, the processing module enables the proximity sensing module, and the proximity sensing module executes proximity sensing.

The proximity sensing method of the disclosure is adapted to a keyboard device. The keyboard device includes multiple keyboard input lines, multiple keyboard output lines, a processing module and a proximity sensing module. The proximity sensing module is coupled to at least one of the keyboard input lines and the keyboard output lines. The proximity sensing method includes the following steps: the proximity sensing module is disabled through the processing module, and key sensing is executed during multiple first sub-periods in a scan period; and the proximity sensing module is enabled through the processing module, and proximity sensing is executed through the proximity sensing module during a second sub-period in the scan period.

Based on the above, the keyboard device and the proximity sensing method of the disclosure can add a sensing period of the proximity sensing module during a keyboard scan period to implement the proximity sensing function.

In order to make the features and advantages of the disclosure more comprehensible, the following examples are given and described in detail with the accompanying drawings as follows.

### BRIEF DESCRIPTION OF THE DRAWINGS

FIG. 1 is a circuit schematic diagram of a keyboard device according to an embodiment of the disclosure.

FIG. 2 is a circuit schematic diagram of a switch unit according to an embodiment of the disclosure.

FIG. 3 is a flow chart of a proximity sensing method according to an embodiment of the disclosure.

FIG. 4 is a schematic diagram of a scan timing according to an embodiment of the disclosure.

FIG. 5A is a signal schematic diagram according to an embodiment of the disclosure.

FIG. 5B is a signal schematic diagram according to another embodiment of the disclosure.

FIG. 6 is a flow chart of a proximity sensing method according to an embodiment of the disclosure.

### DESCRIPTION OF THE EMBODIMENTS

In order to make the content of the disclosure more comprehensible, embodiments in which the disclosure may be implemented are listed as follows. In addition, wherever possible, elements/components/steps with the same reference numerals in the drawings and embodiments represent the same or similar components.

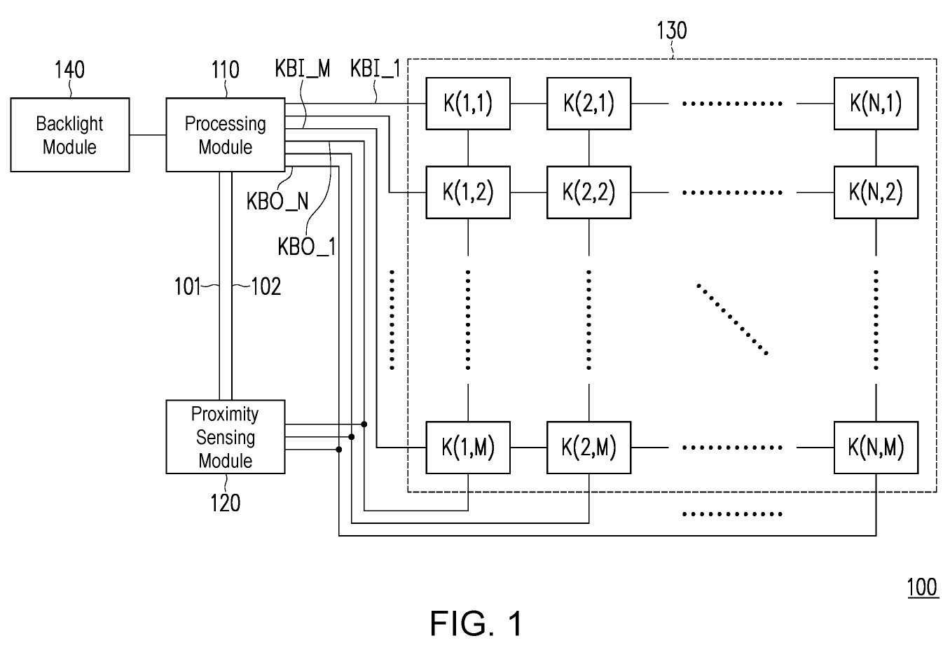

FIG. 1 is a circuit schematic diagram of a keyboard device according to an embodiment of the disclosure. Referring to FIG. 1, a keyboard device 100 includes a processing module 110, a proximity sensing module 120, a keyboard module 130, a backlight module 140, multiple keyboard input lines KBI_1 to KBI_M, and multiple keyboard output lines KBO_1 to KBO_N. M and N are respectively positive integers. The processing module 110 is coupled to the proximity sensing module 120, the keyboard module 130, and the backlight module 140. In an embodiment, the keyboard device 100 may not include the backlight module 140. In the embodiment, the processing module 110 may be a processor, a controller, or other electronic elements having data computation and signal processing functions. In the embodiment, the proximity sensing module 120 may be, for example, a capacitive proximity sensing module or an inductive proximity sensing module.

In the embodiment, the keyboard module 130 includes multiple keyboard switches K(1,1) to K(N,M). The processing module 110 is coupled to the keyboard switches K(1,1) to K(N,M) through the keyboard input lines KBI_1 to KBI_M and the keyboard output lines KBO_1 to KBO_N. In the embodiment, the proximity sensing module 120 is coupled to the keyboard output lines KBO_1 to KBO_N, but the disclosure is not limited thereto. In an embodiment, the proximity sensing module 120 may be coupled to at least one of the keyboard input lines KBI_1 to KBI_M and the keyboard output lines KBO_1 to KBO_N. In an embodiment, the proximity sensing module 120 is coupled in parallel to at least one of the keyboard input lines KBI_1 to KBI_M and the keyboard output lines KBO_1 to KBO_N.

In the embodiment, the keyboard device 100 may be a membrane keyboard device. The keyboard switches K(1,1) to K(N,M) may be multiple membrane switches. In an embodiment, each of the keyboard switches K(1,1) to K(N,M) is formed by circuit intersections of each of the keyboard input lines KBI_1 to KBI_M and each of the keyboard output lines KBO_1 to KBO_N. The keyboard input lines KBI_1 to KBI_M and the keyboard output lines KBO_1 to KBO_N may be multiple membrane traces. In the embodiment, the keyboard input lines KBI_1 to KBI_M and the keyboard output lines KBO_1 to KBO_N are distributed in a key region of the keyboard device 100. The key region refers to a region where an actual keyboard is configured with keys. The keyboard input lines KBI_1 to KBI_M and the keyboard output lines KBO_1 to KBO_N may be, for example, formed in a gap region between different keyboard switches in the keyboard key region. However, the keyboard input lines KBI_1 to KBI_M and the keyboard output lines KBO_1 to KBO_N of the disclosure may also be disposed outside the key region based on a trace disposal need of the keyboard device 100, and are not limited to the embodiment.

In the embodiment, the processing module 110 may further be coupled to the proximity sensing module 120 through a sensing signal line 101 and an enabling signal line 102. The processing module 110 may enable or disable the proximity sensing module 120 through the enabling signal line 102. When the processing module 110 enables the proximity sensing module 120 through the enabling signal line 102, the processing module 110 may obtain a proximity sensing signal generated by the proximity sensing module 120 through the sensing signal line 101.

In an embodiment, the proximity sensing module 120 may be a proximity sensor. The proximity sensing module 120 may generate a corresponding sensing capacitance value based on a sensing result, and take the sensing capacitance value to serve as the proximity sensing signal. In this regard, the processing module 110 may receive the proximity sensing signal to determine whether there is an object approaching based on the sensing capacitance value. In other words, in an embodiment, an operation of proximity determination may be executed by the processing module 110.

In another embodiment, the proximity sensing module 120 may include a proximity sensor and a computing circuit. The proximity sensor of the proximity sensing module 120 may generate a corresponding sensing capacitance value based on a sensing result. The computing circuit of the proximity sensing module 120 may determine whether there is an object approaching based on the sensing capacitance value. Next, the computing circuit of the proximity sensing module 120 may take a determination result to serve as the proximity sensing signal and output the proximity sensing signal to the processing module 110 to notify the processing module 110 of the determination result. In other words, in another embodiment, an operation of proximity determination may be executed by the proximity sensing module 120.

In the embodiment, when at least one of the keyboard switches K(1,1) to K(N,M) is pressed, that is, when a key of the keyboard device 100 is pressed, at least one corresponding keyboard input line and at least one corresponding keyboard output line may be turned on. In addition, it should be noted that the keyboard module 130 shown in FIG. 1 expresses a corresponding relationship between the keyboard switches K(1,1) to K(N,M) and the keyboard input lines KBI_1 to KBI_M, and a corresponding relationship between the keyboard switches K(1,1) to K(N,M) and the keyboard output lines KBO_1 to KBO_N in an array form, rather than an actual arrangement manner of the keyboard keys.

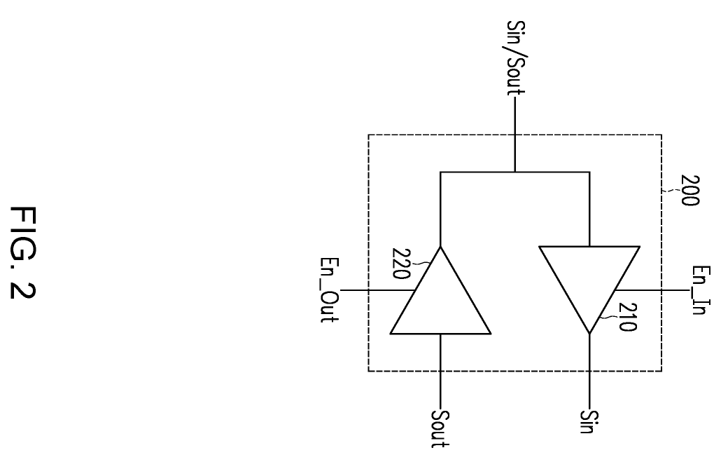

FIG. 2 is a circuit schematic diagram of a switch unit according to an embodiment of the disclosure. Referring to FIGS. 1 and 2, in the embodiment, the processing module 110 may be respectively coupled to the keyboard input lines KBI_1 to KBI_M and the keyboard output lines KBO_1 to KBO_N through multiple switch units coupled to multiple pin endpoints. In the embodiment, each of the multiple switch units may be, for example, implemented with a circuit structure of a tri-state logic gate 200 as shown in FIG. 2. However, the switch units of the disclosure are configured to switch between a signal input, a signal output, or an OFF state among the processing module 110, the keyboard input lines KBI_1 to KBI_M, and the keyboard output lines KBO_1 to KBO_N. The switch units may also utilize a tri-state buffer, a tri-state inverter, an analog switch, or a digital switch, etc. and are not limited to the embodiment.

In the embodiment, as shown in FIG. 2, the tri-state logic gate 200 includes buffers 210 and 220. An input end of the buffer 210 is coupled to an output end of the buffer 220. The input end of the buffer 210 and the output end of the buffer 220 may be coupled to a corresponding keyboard input line or a corresponding keyboard output line by a same pin to provide an output signal Sout to the keyboard input line or the keyboard output line, or to receive an input signal Sin from the keyboard input line or the keyboard output line. An output end of the buffer 210 may be coupled to the processing module 110 to provide the input signal Sin to the processing module 110. An input end of the buffer 220 may be coupled to the processing module 100 to receive the output signal Sout from the processing module 110.

In the embodiment, an enabling end of the buffer 210 may further receive an input enabling signal En_In provided by the processing module 110. An enabling end of the buffer 220 may further receive an output enabling signal En_Out provided by the processing module 110. In the embodiment, the tri-state logic gate 200 may be operated to an input state, an output state, and a high impedance state based on the input enabling signal En_In and the output enabling signal En_Out. For example, when the processing module 100 respectively disables the buffer 210 and the buffer 220 based on the input enabling signal En_In and the output enabling signal En_Out, the tri-state logic gate 200 at this time is in the high impedance state. The high impedance state may be regarded as setting the tri-state logic gate 200 as an open circuit (such as an OFF state of a switch unit) to cut off a signal path between the processing module 110 and the keyboard input lines KBI_1 to KBI_M or between the processing module 110 and the keyboard output lines KBO_1 to KBO_N.

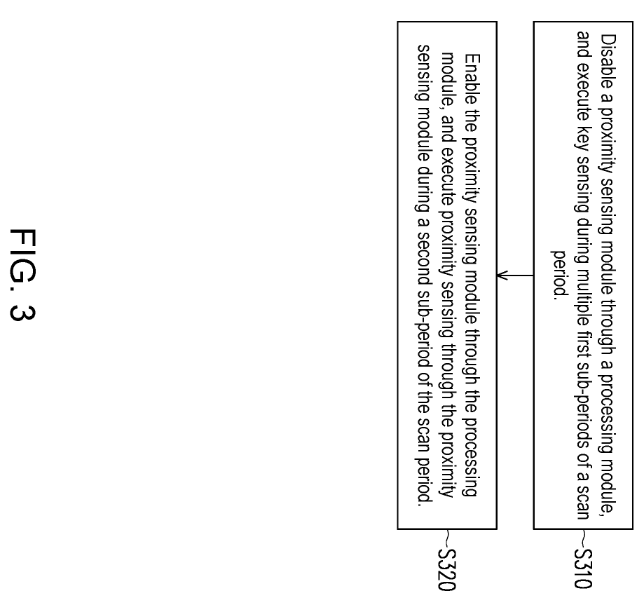

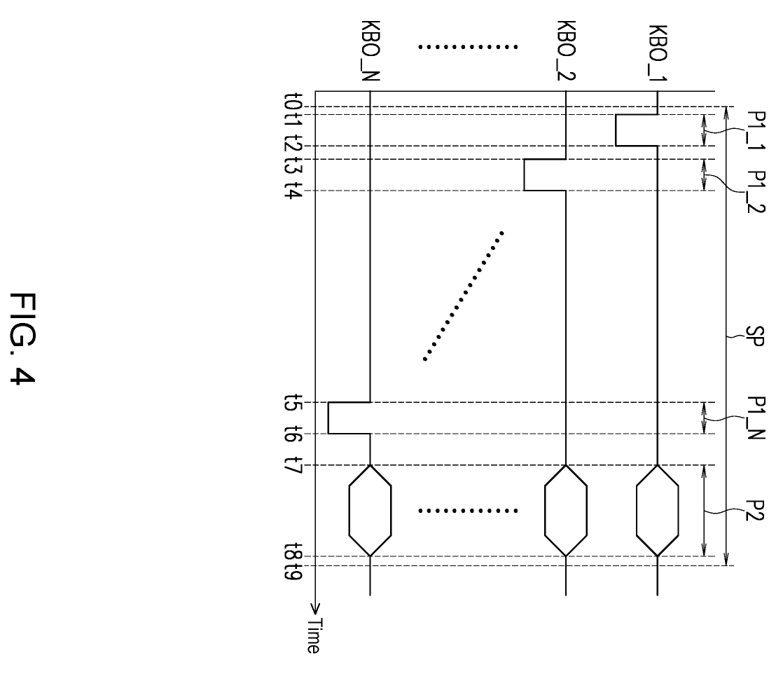

FIG. 3 is a flow chart of a proximity sensing method according to an embodiment of the disclosure. FIG. 4 is a schematic diagram of a scan timing according to an embodiment of the disclosure. Referring to FIGS. 1, 3, and 4, the keyboard device 100 may perform the following steps S310 and S320. In step S310, during multiple first sub-periods P1_1 to P1_N in a scan period SP, the processing module 110 disables the proximity sensing module 120, and executes key sensing. In step S320, during a second sub-period P2 in the scan period SP, the processing module 110 enables the proximity sensing module 120, and executes proximity sensing through the proximity sensing module 120. The processing module 110 may receive a proximity sensing signal generated by the proximity sensing module 120 during the second sub-period P2 in the scan period SP. In the embodiment, the processing module 110 may periodically execute the scan period SP to poll the keyboard output lines KBO_1 to KBO_N and enable the proximity sensing module 120 without limiting an execution order of steps S310 and S320.

In the embodiment, during the first sub-periods P1_1 to P1_N, the processing module 110 sets the keyboard input lines KBI_1 to KBI_M and the keyboard output lines KBO_1 to KBO_N to a normal mode. The normal mode is to take the keyboard input lines KBI_1 to KBI_M and the keyboard output lines KBO_1 to KBO_N to serve as key circuits of the keyboard, sensing an actuation of the keyboard switches K(1,1) to K(N,M) through the keyboard input lines KBI_1 to KBI_M and the keyboard output lines KBO_1 to KBO_N, that is, sensing a key actuation of the keyboard device 100. The processing module 110 may set multiple switch units coupled to the keyboard input lines KBI_1 to KBI_M and the keyboard output lines KBO_1 to KBO_N to the normal mode that may receive or send a scan signal through the input enabling signal En_In and the output enabling signal En_Out as described in the foregoing embodiment of FIG. 2. For example, the buffer 210 may be enabled through the input enabling signal En_In to allow the processing module 110 to receive the scan signal. Alternatively, the buffer 220 may be enabled through the output enabling signal En_Out to allow the processing module 110 to send the scan signal. In the embodiment, the processing module 110 sequentially outputs multiple scan signals to the keyboard output lines KBO_1 to KBO_N, and sequentially senses a signal variation of the keyboard input lines KBI_1 to KBI_M to confirm whether there is a keyboard switch among the keyboard switches K(1,1) to K(N,M) triggered to execute a corresponding key operation. In other embodiments, the processing module 10 may also sequentially output multiple scan signals to the keyboard input lines KBI_1 to KBI_M, and sequentially sense a signal variation of the keyboard output lines KBO_1 to KBO_N, and is not limited to the embodiment.

During the first sub-periods P1_1 to P1_N, the processing module 110 may sequentially adjust a voltage level of each of the keyboard input lines KBI_1 to KBI_M or a voltage level of each of the keyboard output lines KBO_1 to KBO_N to send a scan signal. As shown in FIG. 4, the scan period SP is from time t0 to time t9. The processing module 110 may switch the voltage level of the keyboard output line KBO_1 from a high voltage level to a low voltage level during the first sub-period P1_1 from time t1 to time t2. The processing module 110 may switch the voltage level of the keyboard output line KBO_2 from a high voltage level to a low voltage level during the first sub-period P1_2 from time t3 to time t4. Similarly, the processing module 110 may switch the voltage level of the keyboard output line KBO_M from a high voltage level to a low voltage level during the first sub-period P1_N from time t5 to time t6.

For example, as shown in FIG. 1, assuming the keyboard switch K(2,2) is pressed, so that the keyboard input line KBI_2 and the keyboard output line KBO_2 are turned on. In this way, a scan signal of the keyboard output line KBO_2 may be transmitted to the keyboard input line KBI_2 through the pressed keyboard switch K(2,2) to allow the processing module 110 to effectively determine that the keyboard switch K(2,2) is pressed through sensing a voltage level variation of the keyboard input line KBI_2, and may, for example, output a corresponding input command to a computer host coupled to the keyboard device 100.

Next, during the second sub-period P2 of the scan period SP, the processing module 110 sets the keyboard input lines KBI_1 to KBI_M and the keyboard output lines KBO_1 to KBO_N to an antenna mode. The antenna mode is to take at least one of the keyboard input lines KBI_1 to KBI_M and the keyboard output lines KBO_1 to KBO_N to serve as an antenna circuit of the proximity sensing module, performing proximity sensing through the keyboard input lines KBI_1 to KBI_M and/or the keyboard output lines KBO_1 to KBO_N. During the second sub-period P2, the processing module 110 may set multiple pin endpoints coupled to the keyboard input lines KBI_1 to KBI_M and the keyboard output lines KBO_1 to KBO_N to a floating state to effectively reduce the impact of the processing module 110 on signal lines. The floating state refers to the processing module 110 setting multiple switch units coupled to the keyboard input lines KBI_1 to KBI_M and the keyboard output lines KBO_1 to KBO_N to an OFF state through the input enabling signal En_In and the output enabling signal En_Out as described in the foregoing embodiment of FIG. 2.

In the embodiment, the proximity sensing module 120 may take the keyboard input lines KBI_1 to KBI_M and/or the keyboard output lines KBO_1 to KBO_N to serve as proximity sensing antennas to determine whether an object (such as a user’s palm or finger) is approaching the keyboard device 100 through a signal variation on the keyboard input lines KBI_1 to KBI_M and/or the keyboard output lines KBO_1 to KBO_N.

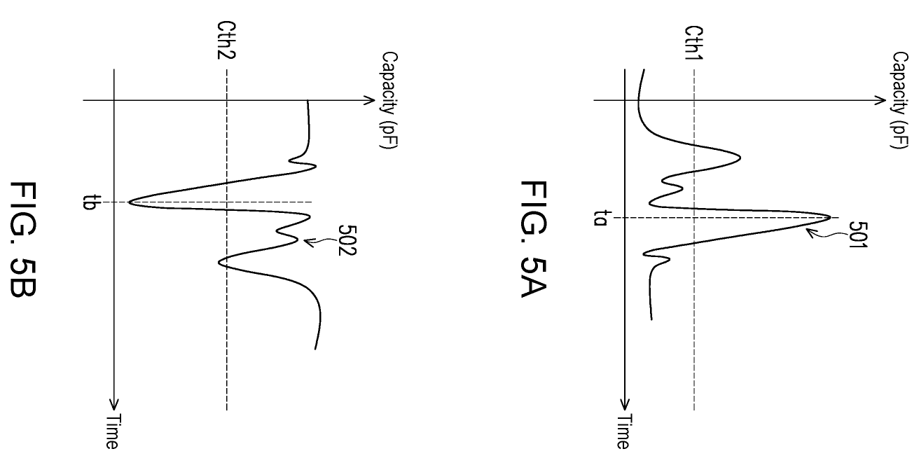

For example, referring to FIG. 5A, FIG. 5A is a signal schematic diagram of an embodiment of the disclosure. Taking a capacitive proximity sensing module where the proximity sensing module 120 is in a self-capacitance mode, and taking the keyboard output lines KBO_1 to KBO_N to serve as antenna circuits of the proximity sensing module 120 as an example, the keyboard output lines KBO_1 to KBO_N may have a non-fixed capacitance value in an initial state. The capacitance value thereof may vary in response to a charge carried by a surrounding object (the capacitance value is inversely proportional to a distance between the object and the keyboard output lines KBO_1 to KBO_N, that is, when the object moves closer to the keyboard output lines KBO_1 to KBO_N, the capacitance value may gradually increase). As shown in FIG. 5A, a curve 501 is configured to represent variations in capacitance value of the keyboard output lines KBO_1. When an object (such as the user’s palm or finger) is not significantly approaching the keyboard output line KBO_1, a capacitance value C of the keyboard output line KBO_1 is below an actuation threshold Cth1 (capacitance threshold). The proximity sensing module 120 determines that no object is approaching. When an object is approaching the keyboard output line KBO_1 at time ta, the proximity sensing module 120 may sense an increase in capacitance value of the keyboard output line KBO_1. In this regard, when the capacitance value of the keyboard output lines KBO_1 to KBO_N exceeds the actuation threshold Cth1 (capacitance threshold), the proximity sensing module 120 may determine that an object is approaching and output a corresponding proximity sensing signal to the processing module 110.

For another example, referring to FIG. 5B, FIG. 5B is a signal schematic diagram of another embodiment of the disclosure. Taking a capacitive proximity sensing module where the proximity sensing module 120 is in a mutual capacitance mode, and taking the keyboard output lines KBO_1 to KBO_N to serve as antenna circuits for the proximity sensing module 120 as an example, the keyboard output lines KBO_1 to KBO_N may have a non-fixed capacitance value in an initial state. The capacitance value may vary in response to a charge carried by a surrounding object (the capacitance value is directly proportional to a distance between the object and the keyboard output lines KBO_1 to KBO_N, that is, when the object moves closer to the keyboard output lines KBO_1 to KBO_N, the capacitance value may gradually reduce). As shown in FIG. 5B, a curve 502 is configured to represent variations in capacitance value of the keyboard output lines KBO_1. When an object (such as a user’s palm or finger) is not significantly approaching the keyboard output line KBO_1, the capacitance value C of the keyboard output line KBO_1 is above the actuation threshold Cth1 (capacitance threshold), and the proximity sensing module 120 determines that no object is approaching. When an object is approaching the keyboard output line KBO_1 at time tb, the proximity sensing module 120 may sense a reduction in capacitance value of the keyboard output line KBO_1. In this regard, when the capacitance value of the keyboard output line KBO_1 is below the actuation threshold Cth1, the proximity sensing module 120 may determine that the object is approaching and output a corresponding proximity sensing signal to the processing module 110.

However, the disclosure is not limited to using all of the keyboard input lines KBI_1 to KBI_M and the keyboard output lines KBO_1 to KBO_N to serve as antennas. In an embodiment, during the second sub-period P2 in the scan period SP, the proximity sensing module 120 may take at least one of the keyboard input lines KBI_1 to KBI_M and the keyboard output lines KBO_1 to KBO_N to serve as at least one proximity sensing antenna to determine whether an object (such as a user’s palm or finger) is approaching the keyboard device 100 through sensing a signal variation of at least one of the keyboard input lines KBI_1 to KBI_M and the keyboard output lines KBO_1 to KBO_N.

In addition, in an embodiment, the second sub-period P2 may also be configured between two periods of the first sub-periods P1_1 to P1_N (for example, the second sub-period P2 may be configured between the first sub-period P1_3 and the first sub-period P1_4). Alternatively, the second sub-period P2 may also be configured before the first sub-periods P1_1 to P1_N or after the first sub-periods P1_1 to P1_N, and is not limited to a final timing as shown in FIG. 4.

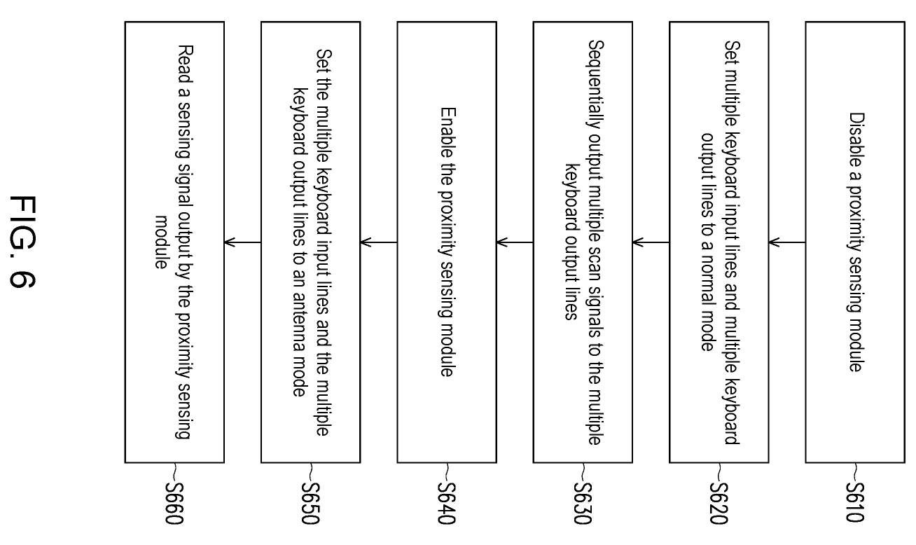

FIG. 6 is a flow chart of a proximity sensing method according to an embodiment of the disclosure. Referring to FIGS. 1 and 6, the keyboard device 100 may perform the following steps S610 to S660. In step S610, the processing module 110 disables the proximity sensing module 120. In step S620, the processing module 110 sets the keyboard input lines KBI_1 to KBI_M and the keyboard output lines KBO_1 to KBO_N to a normal mode. In step S630, the processing module 110 sequentially outputs multiple scan signals to the keyboard output lines KBO_1 to KBO_N. The processing module 110 may scan the multiple keyboard output lines KBO_1 to KBO_N one by one during the multiple first sub-periods P1_1 to P1_N as shown in FIG. 4. In step S640, the processing module 110 enables the proximity sensing module 120. In step S650, the processing module 110 sets the multiple keyboard input lines and the multiple keyboard output lines to an antenna mode. In step S660, the processing module 110 reads a proximity sensing signal output by the proximity sensing module 120. The processing module 110 may enable the proximity sensing module 120 during the second sub-period P2 as shown in FIG. 4. When the second sub-period P2 ends, the processing module 110 may re-execute step S610 to poll the keyboard output lines KBO_1 to KBO_N and read a sensing signal output by the proximity sensing module 120.

It should be noted that the disclosure does not limit the execution order of steps S610 to S660 in FIG. 6. Specifically, the disclosure is not limited to executing proximity sensing after the keyboard input lines KBI_1 to KBI_M and the keyboard output lines KBO_1 to KBO_N are completely scanned. Proximity sensing may also be first executed after a portion of the keyboard input lines KBI_1 to KBI_M and the keyboard output lines KBO_1 to KBO_N are scanned, and then a remaining portion of the keyboard input lines KBI_1 to KBI_M and the keyboard output lines KBO_1 to KBO_N are scanned to allow the keyboard device 100 to flexibly switch and allocate time between proximity sensing and key sensing.

In the embodiment, when the processing module 110 receives the proximity sensing signal, the processing module 110 may determine that an object (such as a user’s palm or finger) is approaching the keyboard device 100. The processing module 110 may drive the backlight module 140 to present a specific light emitting effect.

In summary, the keyboard device and the proximity sensing method of the disclosure may use the existing keyboard input lines and keyboard output lines in the keyboard device to serve as sensing antennas of the proximity sensing module, without the need to add additional wires independent of the keyboard’s own key circuits to serve as sensing antennas. The keyboard device and the proximity sensing method of the disclosure may take the existing key circuits respectively configured for key sensing or proximity sensing through a time-division manner, further ensuring that a key function and a proximity sensing function of the keyboard may both stably operate. In this way, the keyboard device and the proximity sensing method of the disclosure can effectively save additional antenna configuration space and can implement a streamlined keyboard volume.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A keyboard device, comprising:
a plurality of keyboard input lines;
a plurality of keyboard output lines;
a processing module, coupled to the keyboard input lines and the keyboard output lines; and
a proximity sensing module, coupled to at least one of the keyboard input lines and the keyboard output lines;
wherein during a plurality of first sub-periods in a scan period, the processing module disables the proximity sensing module, and executes key sensing;
wherein during a second sub-period in the scan period, the processing module enables the proximity sensing module, and the proximity sensing module executes proximity sensing.

2. The keyboard device according to claim 1, wherein during the second sub-period, the proximity sensing module takes at least one of the keyboard input lines and the keyboard output lines to serve as at least one proximity sensing antenna, and generates a proximity sensing signal based on a signal variation of the keyboard input lines and the keyboard output lines.

3. The keyboard device according to claim 2, further comprising:
a backlight module, coupled to the processing module,
wherein during the second sub-period, when the processing module receives the proximity sensing signal, the processing module drives the backlight module.

4. The keyboard device according to claim 1, wherein during the first sub-periods, the processing module sequentially outputs a plurality of scan signals to the keyboard output lines, and sequentially senses the keyboard input lines.

5. The keyboard device according to claim 1, wherein the processing module is coupled to the keyboard input lines and the keyboard output lines through a plurality of pin endpoints, and during the second sub-period, the processing module sets the pin endpoints to a floating state.

6. The keyboard device according to claim 5, wherein the processing module is coupled to the keyboard input lines and the keyboard output lines through a switch unit at each of the pin endpoints,
wherein during the second sub-period, the processing module sets the switch units to an OFF state.

7. The keyboard device according to claim 1, wherein during the scan period, the second sub-period is between two first sub-periods of the first sub-periods, before the first sub-periods, or after the first sub-periods.

8. A proximity sensing method of a keyboard device, wherein the keyboard device comprises a plurality of keyboard input lines, a plurality of keyboard output lines, a processing module and a proximity sensing module, and the proximity sensing module is coupled to at least one of the keyboard input lines and the keyboard output lines, wherein the proximity sensing method comprises:
disabling the proximity sensing module through the processing module, and executing key sensing during a plurality of first sub-periods in a scan period; and
enabling the proximity sensing module through the processing module, and executing proximity sensing through the proximity sensing module during a second sub-period in the scan period.

9. The proximity sensing method according to claim 8, further comprising:
taking at least one of the keyboard input lines and the keyboard output lines to serve as at least one proximity sensing antenna through the proximity sensing module, and generating a proximity sensing signal based on a signal variation of the keyboard input lines and the keyboard output lines during the second sub-period.

10. The proximity sensing method according to claim 9, further comprising:
wherein during the second sub-period, when the processing module receives the proximity sensing signal, a backlight module is driven through the processing module.

11. The proximity sensing method according to claim 8, wherein the step of executing key sensing comprises:
sequentially outputting a plurality of scan signals to the keyboard output lines through the processing module, and sequentially sensing the keyboard input lines during the first sub-periods.

12. The proximity sensing method according to claim 8, further comprising:
setting a plurality of pin endpoints to a floating state through the processing module during the second sub-period,
wherein the processing module is coupled to the keyboard input lines and the keyboard output lines through the pin endpoints.

13. The proximity sensing method according to claim 12, wherein the processing module is coupled to the keyboard input lines and the keyboard output lines through a switch unit at each of the pin endpoints, and the step of setting the pin endpoints to the floating state comprises:
setting the switch units to an OFF state through the processing module during the second sub-period.

14. The proximity sensing method according to claim 8, wherein during the scan period, the second sub-period is between two first sub-periods of the first sub-periods, before the first sub-periods, or after the first sub-periods.
